(19) United States
(12) Patent Application Publication
(10) Pub. No.: US 2006/0210732 A1
(43) Pub. Date: Sep. 21, 2006

(54) Ink-jet recording sheet and production method of the same

(75) Inventors: Kunimasa Hiyama, Tokyo (JP); Junji Ito, Kobe-shi (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/370,122

(22) Filed: Mar. 7, 2006

(30) Foreign Application Priority Data
Mar. 16, 2005 (JP) JP2005-075099

(51) Int. Cl. B41M 5/00

(52) U.S. Cl. 428/32.24

(57) ABSTRACT

An ink-jet recording sheet containing a support having thereon an ink absorptive layer containing inorganic microparticles, a binder and a compound represented by Formula (1):

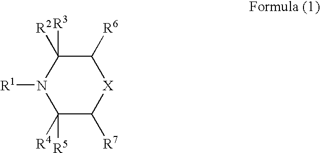

This appliction is based on Japanese Patent Application No. 2205-075099 filed on Mar. 16, 2005 in Japanese Patent Office, the entire content of which is hereby incorporated by reference.

### TECHNICAL FIELD

The present invention relates to an ink-jet recording sheet and the production method of the same, and in more detail, to an ink-jet recording sheet which results in improved light fastness and color forming properties, as well as minimizes bleeding over an elapse of time and non-uniformity, and the production method of the same.

### BACKGROUND

In recent years, ink-jet recording materials have been increasingly subjected to improvement of their image quality, and the quality of recorded color images, employing ink-jet recording devices, is approaching that produced by silver salt photosensitive photographic materials. Specifically, in order to realize, by employing ink-jet recording, image quality comparative to that of conventional photography, ink-jet recording sheets (hereinafter also referred to simply as recording sheets) have been improved. A void type ink-jet recording sheet, which incorporates a very smooth support having thereon a porous layer composed of minute particles and hydrophilic polymers, is becoming one of the sheets which results in nearest conventional photographic quality, due to its high glossiness and bright color formation, or excellent ink absorbability and drying properties. Specifically, when a non-water absorptive support is employed, cockling, or so-called wrinkling, which is observed in a water absorptive support, does not occur, enabling production of higher quality prints. Consequently, such sheets have gradually formed a main current of photographic prints produced by ink-jet recording.

On the other hand, along with the recent progress of ink, fading due to gases has been reduced. However, it is not possible to state that light fastness has reached the desired level, whereby further improvement of the light fastness is demanded.

Heretofore, in order to improve the above light fastness, proposed is a method in which UV absorbers are incorporated in ink-jet recording sheets as well as a method in which various antioxidant based anti-fading agents are incorporated. However, it is difficult to state that sufficient effects are exhibited by only employing conventional methods. For example, known as anti-fading agents are hydroxylamine compounds having a specified structure (refer to Patent Document 1). However, when intended to improve light fastness employing only the aforesaid compounds, image bleeding results over an elapse of time. Specifically, when incorporated in porous ink-jet recording sheets, problems such as cracking tend to occur on the layer surface.

Further, it is known that hindered amine compounds having a specified structure exhibit anti-fading effects (refer to Patent Documents 2 and. 3). However, when the aforesaid compounds are incorporated in ink-jet recording sheets, problems have occurred in which cracking tends to occur on the layer surface and bleeding degradation tends to result over an elapse of time.

(Patent Document 1) Japanese Patent Publication for Public Inspection (hereinafter referred to as JP-A) No. 9,-267544

(Patent Document 2) JP-A No. 4-34512

(Patent Document 3) JP-A No. 2000-94829

### SUMMARY

In view of the foregoing, the present invention was achieved. An object of the present invention is to provide an ink-jet recording sheet which results in improved light fastness and color forming properties, as well as minimizes bleeding and non-uniformity over an elapse of time, and the production method of the same.

The above object of the present invention was achieved employing the following embodiments.
(1) One of the embodiments of the present invention includes an ink-jet recording sheet comprising a support having thereon an ink absorptive layer comprising inorganic microparticles, a binder and a compound represented by Formula (1):

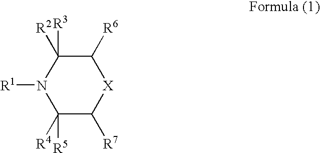

wherein R¹ represents a hydrogen atom, a hydroxyl group, an alkyl group, an alkenyl group, or an acyl group; R², R³, R⁴, and R5 each independently represents a hydrogen atom, a methyl group , or an ethyl group; R⁶ and R⁷ each independently represents a hydrogen atom or a methyl group; X represents a chalcogen atom, N(R⁹), or C(R⁹) (R¹⁰) in which R⁸, R⁹, and R¹⁰ each independently represents a hydrogen atom or a substituent.
(2) Another embodiment of the present invention includes an ink-jet recording sheet of the above-described item 1,

wherein R¹ in Formula (1) represents a hydroxyl group.
(3) Another embodiment of the present invention includes an ink-jet recording sheet of the above-described items 1 or 2,

wherein the compound represented by Formula (1) has a molecular weight of not more than 300.
(4) Another embodiment of the present invention includes an ink-jet recording sheet of any one of the above-described items 1 to 3, comprising at least two ink absorptive layers,

wherein the compound represented by Formula (1) is contained within a distance of 60% of the total thickness of the ink absorptive layers, the distance being measured from a surface of the support on which the ink absorptive layers are provided.
(5) Another embodiment of the present invention includes an ink-jet recording sheet of the above-described item 4,

wherein at least one of the ink absorptive layers comprises a polyvalent metal compound, and 80 mole % of the total mol of the polyvalent metal compound is contained within a distance of 60% of the total thickness of the ink absorptive layers, provided that the distance is measured from a surface of the uppermost ink absorptive layer.
(6) Another embodiment of the present invention includes a method of producing an ink-jet recording sheet of any one of the above-described items 1 to 4 comprising the steps of:

preparing a dispersion of the inorganic microparticles;

adding the compound represented by Formula (1) to the dispersion of inorganic microparticles;

mixing the binder to the dispersion of inorganic microparticles added with the compound represented by Formula (1) so as to obtain a coating composition;

applying the coating composition onto the support.

It was possible to provide an ink-jet recording sheet which results in improved light fastness and color forming properties, as well as minimizes bleeding over an elapse of time and non-uniformity, and the production method of the same by the above-described embodiments.

### DESCRIPTION OF THE PREFERRED EMBODIMENTS

In the present invention, in an ink-jet recording sheet which incorporates a support having thereon at least one ink receptive layer incorporating minute inorganic particles and binders, by constituting the sheet in such a manner that at least one layer of the above ink receptive layers incorporates the compounds represented by above Formula (1), whereby it is possible to provide an ink jet recording sheet which results in improved light fastness and color forming properties and minimizes bleeding and non-uniformity over an elapse of time, and the production method of the same.

The present invention will now be detailed.

(Compounds Represented by Formula (1))

The ink receptive layer of the ink jet recording sheet of the present invention incorporates the compounds represented by above Formula (1), namely hindered amine compounds.

wherein R¹ represents a hydrogen atom, a hydroxyl group, an alkyl group, an alkenyl group, or an acyl group; R², R³, R⁴, and R⁵ each represent a hydrogen atom, a methyl group , or an ethyl group; each of R⁶ and R⁷ represents a hydrogen atom or a methyl group; X represents an atom classified to chalcogen (also referred to as oxygen group elements), N(R⁹), or C(R⁹) (R¹⁰) in which R⁸, R⁹, and R¹⁰ each represent a hydrogen atom or a substituent.

Listed as the preferred alkyl groups represented by R¹ are alkyl groups having 1-8 carbon atoms, such as a methyl group, an ethyl group, or a propyl group, while listed as the preferred alkenyl group is an aryl group, and listed as the preferred acyl group is an acetyl group.

Listed as the preferred atoms represented by X, which are classified to chalcogen, are atoms such as oxygen, sulfur or selenium.

Listed as the preferred substituents represented by R⁸-R¹⁰ are a methyl group, an ethyl group, a hydroxyl group, a methoxy group, a 2-oxopropionyl group, and a pyruvoyl group.

Specific examples represented by Formula (1) are listed below, however the preset invention is not limited thereto.

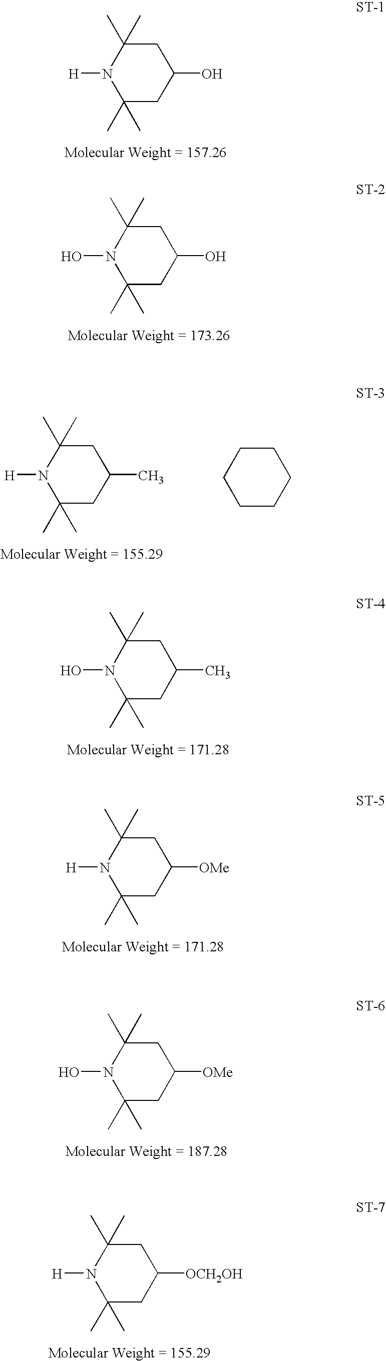

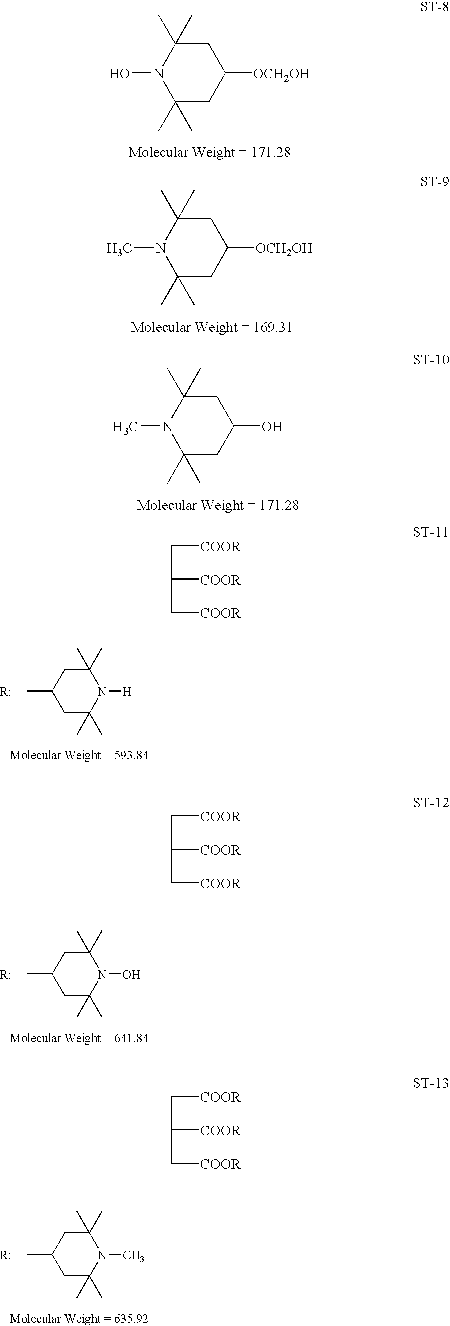

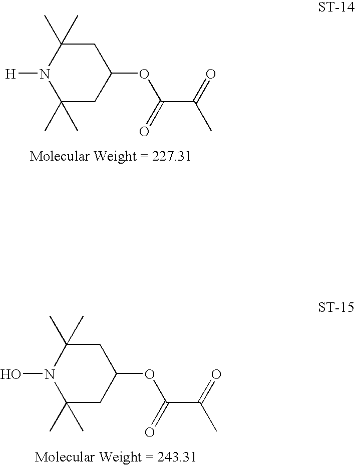

Of the compounds represented by Formula (1), preferred are those which are soluble in water, or aqueous acidic solutions such as an aqueous acetic acid solution, an aqueous citric acid solution, or an aqueous nitric acid solution. Further preferred are those in which the substituent represented by above R¹ is a hydroxyl group. Those of a molecular weight of at most 300 are preferably employed because of their high water solubility. As used herein, the term “soluble in water or aqueous acidic solutions” means that solubility in water or aqueous acidic solutions is at least 10 percent at normal temperature.

The above hindered amine compounds according to the present invention are employed as follows. After preparing their aqueous solution at an optional concentration, the resulting solution is impregnated into a layer after coating of a receptive layer. Alternatively, they are blended with a liquid coating composition incorporating minute inorganic particles and binders and then coated. It is preferable that the aforesaid compounds are added to a minute inorganic particle dispersion, and the resulting mixture is blended with binders. Further, it is specifically preferred that they are blended during the process in which minute inorganic particles are dispersed in water.

By adding the above hindered amine compound during the dispersion process of silica particles, the hindered amine compound can be adsorbed on the surface of silica particles. This adsorption allows the hindered amine to be placed in the vicinity of the dye of the ink and, at the same time, it is considered to be effective to prevent the diffusion of the dye in the ink absorptive layer during the king-term storage.

In the present invention, it is preferable that the compounds represented by Formula (1) are allowed to exist so that their concentration is higher on the side of the ink receptive layer near the support. Specifically, when the portion of the ink receptive layer which is within at least 60 percent from the support is defined as a lower layer, it is preferable that the compounds represented by Formula (1), which are to be incorporated in the ink receptive later, are added to a lower layer ink receptive layer liquid coating composition and then employed.

The content of the compounds represented by Formula (1) according to the present invention is commonly about 0.01-about 5 g per m² of the recording sheet, but is preferably 0.05-1 g.

(Inorganic Microparticles)

The ink absorptive layer of the ink-jet recording sheet of the present invention contains mainly inorganic microparticles and a hydrophilic binder. Listed examples of inorganic microparticles employed in the ink absorptive layer are as follows: precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, vapor phase method silica, wet system silica, colloidal silica, alumina, colloidal alumina, pseudo-boehmite, aluminum hydroxide, lithopone, zeolite, and magnesium hydroxide. It is possible to employ the above minute inorganic particles in the form of a primary particle without any further modification or in the state in which secondary aggregated particles are formed.

In the present invention, to obtain high quality prints employing these ink-jet recording sheets, silica or alumina based particles are preferred; further, alumina, pseudo-boehmite, colloidal silica, or minute silica synthesized employing a vapor phase method are preferred. Among them, minute silica particles synthesized employing a vapor phase method, are particularly preferred.

Silica synthesized employing the above vapor phase method may be one of which the surface is modified with aluminum. The content ratio of aluminum in the vapor phase method silica of which the surface is modified with aluminum is preferably 0.05-5 percent by weight with respect to silica.

Any particle diameter can be employed for the above-described inorganic microparticles. However, preferred is an average particle diameter of not more than 1 μm. When it is more than 1 μm, glossiness and formed color density tend to be decreased. Therefore, more preferred average particle diameter is not more than 200 nm. Still more preferred average particle diameter is not more than 100 nm. The lower limit of the particle diameter is not particularly limited, but in view of production of the minute inorganic particles, the diameter is preferably not less than 3 nm and particularly preferred is not less than 5 nm.

The average diameter of the above minute inorganic particles is determined as follows. The cross section and surface of a porous ink absorptive layer are observed employing an electron microscope and the diameter of each of 100 randomly selected particles is determined, whereby a simple average value (being a number average) is obtained. Herein, each particle diameter is represented by the diameter of a circle which has the same area as the projective area of the particle.

The above minute inorganic particles may be present in the porous layer in the form of primary particles, or of secondary or higher order aggregated particles. The above average particle diameter refers to the diameter of independent particles in the ink absorptive layer when observed employing an electron microscope.

The average diameter of the primary particles of the above-described inorganic microparticles is required to be less than the average particle diameter observed in the porous layer. The primary particle diameter of minute inorganic particles is preferably less than 100 nm, more preferably less than 30 nm, and still more preferably it is 4-20 nm.

The content of the above minute inorganic particles in a water-soluble liquid coating composition is 5-40 percent by weight, but is particularly preferably 7-30 percent by weight. The above minute inorganic particles are required to form an ink absorptive layer which sufficiently absorbs ink and results in minimal layer cracking. Consequently, the coated amount in the ink absorptive layer is preferably 5-50 g/m², but is particularly preferably 10-25 g/m².

(Binder)

Hydrophilic binders which are applicable to the ink absorptive layer according to the present invention are not particularly limited, and it is possible to employ conventional hydrophilic binders. Examples of binders are: gelatin, polyvinylpyrrolidone, polyethylene oxide, polyacrylamides, and polyvinyl alcohol. Of these, polyvinyl alcohol is particularly preferred.

Polyvinyl alcohol is a polymer which exhibits a mutual interaction for minute inorganic particles, a particularly high retention force to minute inorganic particles, and hygroscopicity of relatively low moisture dependence. Further, its shrinkage stress is relatively small, resulting in excellent cracking resistance during coating and drying.

Polyvinyl alcohols preferably employed in the present invention include, other than common polyvinyl alcohol prepared by hydrolyzing polyvinyl acetate, modified polyvinyl alcohols such as polyvinyl alcohol in which chain terminals have undergone cationic modification or anion-modified polyvinyl alcohol having an anionic group.

Further, included is photo-crosslinking type polyvinyl alcohol which is prepared in such a manner that polyvinyl alcohol, having a crosslinking group on the side chain, undergoes crosslinking in the presence of photoinitiators.

Preferably employed as polyvinyl alcohol prepared by hydrolyzing vinyl acetate are those having an average degree of polymerization of at least 300, but those having an average degree of polymerization of 1,000-5,000 are particularly preferably employed. Those having a saponification ratio of 70-100 percent are preferred, while those of 80-99.8 percent are particularly preferred.

Listed as a cation-modified polyvinyl alcohol is one having a primary, secondary, or tertiary amino group, or a quaternary amino group on the main or branched chain of the above polyvinyl alcohol, as described, for example, in JP-A No. 61-10483. This is prepared by saponifying a copolymer of ethylenic unsaturated monomers, having a cationic group, with vinyl acetate.

Listed as ethylenic unsaturated monomers having a cationic group are, for example, tri-methyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyltrimethylammonium chloride, and trimethyl-(3-methacrylamidopropyl)ammonium chloride.

The ratio of monomers having a cation-modified group of the cation-modified polyvinyl alcohol is commonly 0.1-10 mol percent with respect to vinyl acetate, but is preferably 0.2-5 mol percent.

Listed as anion-modified polyvinyl alcohols are, for example, polyvinyl alcohol having an anionic group, described in JP-A No. 1-206088, copolymers of vinyl alcohol with vinyl compounds having a water-solubilizing group, described in JP-A Nos. 61-237681 and 63-307979, and modified polyvinyl alcohol having a water-solubilizing group, described in JP-A No. 7-285265.

Further listed as nonion-modified polyvinyl alcohols are, for example, polyvinyl alcohol derivatives partially added with a polyalkylene oxide group, described in JP-A No. 7-9758, and block copolymers of polyvinyl alcohol with hydrophobic group-containing vinyl compounds, described in JP-A No. 8-25795.

Listed as such ultraviolet radiation crosslinking type modified polyvinyl alcohol is, for example, polyvinyl alcohol having a photoreactive side chain, as described in JP-A No. 2004-262236.

It is possible to simultaneously use at least two polyvinyl alcohols which differ in degree of polymerization or type of modification. Specifically, in the case of the use of polyvinyl alcohol at a degree of polymerization of at least 2,000, it is preferable that polyvinyl alcohol at a degree of polymerization of at least 2,000 is initially added to minute inorganic particles in an amount of 0.05-10 percent by weight with respect to the minute organic particles, but preferably 0.1-5 percent by weight, and subsequently, the above polyvinyl alcohol is added, resulting in no marked increase in viscosity.

The ratio of inorganic micro-particles against a hydrophilic binder of an ink absorptive layer is preferably 2-20 based on a weight ratio. When the weight ratio is not less than 2 times, a porous layer having a sufficient void ratio can be obtained to easily provide a sufficient void volume, and a state of clogging of the void due to swelling of a hydrophilic binder at the time of ink-jet recording can be avoided, which will be a factor to maintain high ink absorptive rate. On the other hand, when the ratio is not more than 20, cracking is hardly caused at the time of an ink-jet absorptive layer being coated at a heavy thickness. The ratio of inorganic micro-particles against a hydrophilic binder is specifically preferably 2.5-12 times and most preferably 3-10 times.

(Hardening Agents)

In the ink-jet recording sheet of the present invention, in order to prepare a layer exhibiting excellent glossiness and a high void ratio, without degrading brittleness, it is preferable that polyvinyl alcohol is hardened by hardening agents.

Hardeners utilized in this invention are not specifically limited provided causing hardening reaction with a water-soluble binder; however, boric acid and salt thereof are preferred. In addition to these, those commonly known can be utilized, and compounds provided with a group reactive with a water-soluble binder or compounds which accelerate a reaction between different groups, with which a water-soluble binder is provided, each other are generally utilized by appropriate selection depending on the type of a water-soluble binder. Specific examples of a hardener include, epoxy type hardeners (such as diglycidyl ethyl ether, ethyleneglycol diglycidyl ether, 1,4-butanediol diglycidyl ether, 1,6-diglycidyl cyclohexane, N,N-diglycidyl-4-glycidyl oxyaniline, sorbitol polyglycidyl ether and glycelol polyglycidyl ether), aldehyde type hardeners (such as formaldehyde and glyoxal), active halogen type hardeners (such as 2,4-dichloro-4-hydroxy-1,3,5-s-triazine and bisvinylsulfonyl methyl ether), boric acid and the salt thereof, aluminum alum and isocyanate compounds. Among them, preferred are boric acid and salt thereof, epoxy type hardeners and isocyanate compounds.

Boric acid and salt thereof refers to an oxyacid having a boron atom as the center atom and salt thereof, and specifically include orthoboric acid, diboric acid, metaboric acid, tetraboric acid, pentaboric acid, octaboric acid, and salt thereof.

The used amount of hardening agents varies depending on the type of polyvinyl alcohol, the type of hardening agents, 21 7517 polyvinyl alcohol, while it is commonly 5-500 mg per g of polyvinyl alcohol, but is preferably 10-300 mg.

The above hardening agents, when a porous layer forming water-soluble liquid coating composition is to be coated, may be incorporated in the above liquid coating composition. Alternatively, after coating and drying such a porous layer forming water-soluble liquid coating composition (incorporating no hardening agent), the above hardening agents may be provided by overcoating a solution incorporating them.

(Cationic Polymers)

In the ink-jet sheet of the present invention, to minimize image bleeding during storage after recording, cationic polymers may be employed in the ink receptive layer.

Examples of cationic polymers include polyethyleneimine, polyallylamine, polyvinylamine, dicyandiamidopolyalkylene polyamine condensation products, polyalkylenepolyamine dicyandiamidoammonium salt condensation products, dicyandiamido formalin condensation products, epichlorohydrine dialkylamine addition polymerization products, diallyldimethylammonium chloride polymers, diallyldimethylammonium chloride.SO₂ copolymers, polyvinylimidazole, polyvinylpyrrolidone, vinylimodazole copolymers, polyvinyl pyridine, polyamidine, chitosan, cationized starch, vinylbenzyltrimethylammonium chloride polymers, (2-methacroyloxyethyl)trimethylammonium chloride polymers, and dimethylaminoethyl methacrylate polymers. Of these, cationic polymers composed of quaternary amine are particularly preferred.

Listed further as examples are cationic polymers, described in Kagaku Kogyo Jiho, Aug. 15 and 25, 1998, as well as polymer dye fixing agents described in “Kobunshi Yakuzai Nyumon (Introduction to Polymer Agents)”, issued by Sanyo Chemical Industries, Co., Ltd.

Cationic polymers are employed in the range of commonly 0.1-10 g per m² of the ink-jet recording sheet but preferably 0.2-5 g.

(Polyvalent Metal Compounds)

In the ink-jet recording sheet of the present invention, it is possible to incorporate polyvalent metal compounds in the ink receptive layer.

Listed as polyvalent metal compounds related to the present invention may, for example, be those of aluminum, potassium, magnesium, zinc, iron, strontium, barium, nickel, copper, scandium, gallium, indium, titanium, zirconium, tin, and lead. Of these, compounds comprising magnesium, aluminum, zirconium, calcium, and zinc are preferred due to their transparency. Polyvalent metal compounds incorporating zirconium atoms, aluminum atoms, or magnesium atoms are more preferred, but polyvalent metal compounds incorporating zirconium atoms are most preferred.

Compounds (excluding zirconium oxide and aluminum oxide) incorporating zirconium atoms, aluminum atoms, or magnesium atoms may be water-soluble or water-insoluble, but preferred are those which can uniformly be incorporated in the desired position of the ink absorptive layer.

In the present invention, the portion of a layer, in which the polyvalent metal compounds are incorporated, is within 60 percent from the surface, in terms of thickness of the ink receptive layer. However, it is particularly preferable that at least 80 percent of the total polyvalent metal compounds in the ink receptive layer is present in the above portion.

(Supports)

Appropriately employed as supports used in the present invention may be conventional ink-jet recording sheets known in the art. They may be water absorptive, but are preferably non-water absorptive.

Listed as usable water absorptive supports in the present invention may, for example, be common paper, fabrics, and sheets or plates comprising wood. Especially, paper is most preferred due to its high absorptive property and low cost.

Employed as paper supports may be those prepared by using, as a main raw material, chemical pulp such as LBKP and NBKP, mechanical pulp such as GP, CGP, RMP, TMP, CTMP, VMP, or PGW, and wood pulp such as waste paper pulp including DIP. In addition, if desired, it is possible to suitably use synthetic pulp and various fibrous materials such as synthetic fibers or inorganic fibers.

If desired, it is possible to incorporate, into the above paper supports, various conventional additives such as sizing agents, pigments, paper strength enhancing agents, fixing agents, optical brightening agents, wet paper strengthening agents, and cationizing agents.

Paper supports are prepared using a mixture of fibrous materials such as wood pulp with various additives while employing any of the various paper making machines such as a Fourdrinier paper machine, a cylinder paper machine, or a twin wire paper machine. Further, if desired, size press treatments using starch or polyvinyl alcohol are conducted during the paper making stage or employing a paper making machine, and various coating treatments as well as calender finishing may be carried out.

The support used for the ink-jet recording sheet of the present invention is most preferably non-water absorptive supports.

Non-water absorptive supports preferably usable in the present invention include transparent and opaque supports. Listed as transparent supports are films comprising materials such as polyester based resins, diacetate based resins, triacetate based resins, acryl based resins, polycarbonate based resins, polyvinyl chloride based resins, polyimide based resins, cellophane, or celluloid. Of these, preferred are those which are resistant to radiation heat when used for an overhead projector (OHP), and polyethylene terephthalate is particularly preferred. The thickness of such transparent supports is preferably 50-200 μm.

Preferred as opaque supports are, for example, resin coated paper (so-called RC paper) carrying a polyolefin resin covering layer incorporating pigments on at least one side of the base paper, and so-called white PET which is prepared by incorporating white pigments such as bariums sulfate into polyethylene terephthalate.

To enhance adhesion between any of the various above supports and the ink absorptive layer, it is preferable to apply a corona discharge treatment or a subbing treatment to the supports prior to coating of the ink absorptive layer. Further, the ink-jet recording sheets of the present invention need not always be colorless, but may be colored.

In the present invention, it is particularly preferred to employ, as ink-jet recording sheets, paper supports prepared by laminating both sides of a paper substrate with polyethylene, since it is thereby possible to produce at low cost high quality images approaching conventional photographic quality.

Paper supports, which are laminated with polyethylene, will now be described.

Base paper employed for a paper support is produced employing wood pulp as a main raw material, and if desired, employing synthetic pulp such as polypropylene, or synthetic fiber such as nylon or polyester. As wood pulp, for example, any of LBKP, LBSP, NBKP, NBSP, LDP, NDP, LUKP, and NUKP may be employed. However, LBKP, NBSP, LBSP, NDP, and LDP, having shorter fibers, are preferably employed in a larger proportion. However, the content proportion of LBSP or LDP is preferably from 10 to 70 percent by weight.

As the above pulp, chemical pulp (sulfate salt pulp and sulfite pulp) containing minimum impurities is preferably employed, and pulp, which has been subjected to a bleaching treatment to increase whiteness, is also beneficial.

It is possible to appropriately incorporate, into the base paper, sizing agents such as higher fatty acids or alkylketene dimers, white pigments such as talc or titanium oxide, paper strength enhancing agents such as starch, polyacrylamide, or polyvinyl alcohol, optical brightening agents, moisture retaining agents such as polyethylene glycol, dispersing agents, and softening agents such as quaternary ammonium.

The freeness of pulp used for paper making is preferably 200-500 ml under the CSF specification, while in fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 percent by weight or less.

The basic weight of base paper is preferably 30-250 g, but is more preferably 50-200 g, while the thickness of the base paper is preferably 40-250 μm.

Base paper may result in high smoothness employing calender finishing during or after paper making. The density of base paper is customarily 0.7-1.2 g/cm³ (JIS P 8118). Further, the stiffness is preferably 20-200 g under conditions specified in JIS P 8153.

Surface sizing agents may be applied onto the surface of a paper base. Employed as such surface sizing agents may be those which are the same as those capable of being incorporated in the above base paper.

The pH of base paper, when determined by the hot water extraction method specified in JIS P 8113, is preferably 5-9.

Polyethylene which is employed to cover either or both surfaces of base paper is comprised of mainly low density polyethylene (LDPE) and/or high density polyethylene (HDPE). However, it is possible to partly use LLDPE and polypropylene.

Specifically, preferred is a polyethylene layer, on the ink absorptive layer side, of which opacity and whiteness are improved by incorporating rutile or anatase type titanium oxide into the polyethylene as widely applied to photographic print paper. The content of titanium oxide is commonly 3-20 percent by weight with respect to polyethylene, but is preferably 4-13 percent by weight.

The polyethylene-coated paper is commonly employed as a glossy paper. In the present invention, further, it is possible to use polyethylene coated matte or silk surfaced paper, which is prepared as follows. When polyethylene is coated onto the surface of base paper via melt extrusion, a matte or silk surface is formed on common photographic paper by employing so-called embossing treatments.

In the above polyethylene coated paper, it is particularly preferable to maintain the moisture content of the paper in the range of 3-10 percent by weight.

In the present invention, other than those described above, incorporated may be various types of additives. For example, incorporated may be various prior art additives such as water based emulsions incorporating polystyrene, polyacrylates, or polymethacrylates, urea and analogues thereof, UV absorbers, anti-fading agents, optical brightening agents, light fastness enhancing agents, pH controlling agents such as sodium hydroxide or sodium acetate, antifoaming agents, antiseptic agents, thickening agents, antistatic agents, and matting agents.

During production of the ink-jet recording sheets of the present invention, it is possible to apply, onto a support, the constituting layers such as an ink absorptive layer according to the present invention, employing an appropriate method selected from conventional methods. By employing the preferred method, a liquid coating composition, which constitutes each of the layers, is applied onto a support and subsequently dried. In this case, it is possible to simultaneously apply at least two layers onto a support. Examples of coating methods which are preferably employed include a roller coating method, a rod bar coating method, an air knife coating method, a spray coating method, a curtain coating method, or a slide bead coating method and an extrusion coating method using a hopper, described in U.S. Pat. No. 2,681,294.

When at least two ink absorptive layers are simultaneously coated, the viscosity of each of the liquid coating compositions is preferably in the range of 5-100 mPa·s while employing a slide bead coating system, but is more preferably in the range of 10-50 mPa·s. Further, when a curtain coating system is employed, the above viscosity is preferably in the range of 5-1,200 mPa·s, but is more preferably in the range of 25-500 mPa·s.

Further, the viscosity of the liquid coating composition at 15° C. is preferably at least 100 mPa·s, is more preferably 100-30,000 mPa·s, is still more preferably 3,000-30,000, but is most preferably 10,000-30,000 mPa·s.

It is preferable to achieve coating-and drying as follows. After liquid coating compositions heated to at least 30° C. are subjected to simultaneous multilayer coating, the resulting coating is temporarily chilled to 1-15° C. and then dried at 10° C. or higher. During preparations of liquid coating compositions, as well as during their coating and drying, it is preferable to prepare, coat, and dry the liquid coating compositions at a temperature equal to or lower than the Tg of thermoplastic resins so that the above thermoplastic resins incorporated in the surface layer are subjected to no film forming. It is more preferable to achieve drying under the conditions in which the wet bulb temperature is in the range of 5-50° C., and the coating surface temperature is in the range of 10-50° C. Further, it is preferable that employed as a cooling system immediately after coating is a horizontal setting system to achieve uniform coating.

Further, in cases in which photo-linking type polyvinyl alcohol is employed as a binder, it is preferable that ionization radiation, such as ultraviolet radiation or electron beams, is exposed to the formed layer after coating, which is subsequently dried.

(Ink)

The recording sheets of the present invention are suitably employed for colorant containing inks such as a water based pigment ink or a water based dye ink.

Water based dye ink, as described herein, refers to ink employing water-soluble dyes as a colorant. The above ink is composed of water or a mixture of highly water compatible organic solvents as an ink solvent. Commonly employed dyes include acid dyes, direct dyes or basic dyes in which the water solubility is increased by introducing a sulfo group or a carboxyl group into conventional dyes such as azo based dyes, xanthene based dyes, phthalocyanine based dyes, quinone based dyes, or anthraquinone based dyes.

On the other hand, employed as pigments used in the pigment ink may be various inorganic or organic pigments known in the art. Listed as examples of inorganic pigments may be carbon black, titanium oxide, and iron oxide. Further listed as organic pigments may be various types of azo based pigments, phthalocyanine based pigments, anthraquinone based pigments, quinacridone based pigments, and indigo based pigments, as well as chelate pigments prepared by allowing water-soluble dyes to react with polyvalent metal ions.

It is preferable that these pigment particles are employed together with various types of dispersing agents and dispersion stabilizing agents such as hydrophilic polymers or surface active agents. Further, it is preferable to employ pigment particles which are dispersed to exhibit an average particle diameter of about 70-about 150 μm, employing the above dispersing agents and the dispersion stabilizing agents.

The concentration of the above dyes and pigments as a colorant in ink varies depending on the type of dyes or pigments, the employed state of ink (whether dark or pale ink is employed), and the type of recording sheets, but is commonly 0.2-10 percent by weight.

Various types of solvents are employed in a colorant containing ink. Employed as such ink solvents may be water or organic solvents which are highly compatible with water. They may be employed individually or in combination with water. Specific examples include alcohol based solvents such as ethanol, 2-propanol, ethylene glycol, propylene glycol, glycerin, 1,2-hexanediol, 1,6-hexanediol, diethylene glycol monomethyl ether, or tetraethylene glycol monomethyl ether, amines such as 2-pyrrolidinone, N-methylpyrrolidone, N,N-dimethylacetamide, amines such as triethanolamine, N-ethylmorpholine, or triethylenetetramine, sulfolane, dimethylsulfoxide, urea, acetonitrile, and acetone. These solvents may be employed individually or in combination.

Further, for the purpose of the enhancement of penetration of ink solvents as well as for other purposes, it is possible to incorporate various surface active agents in the above colorant containing ink. Preferably employed as such surface active agents are anionic or nonionic ones. Of these, acetylene glycol based surface active agents are particularly preferred.

### EXAMPLES

The present invention will now be specifically described with reference to examples, however the present invention is not limited thereto.

### Example 1

<<Preparation of Silica Dispersion>>

(Preparation of Silica Dispersion D-1)

| | | |
|---|---|---|
| Water | 4000 | ml |
| Boric acid | 17 | g |
| Borax | 20 | g |
| 25% aqueous Cationic Polymer (P-1) solution | 100 | ml |
| 10% aqueous antifading agent solution | 120.5 | ml |

As minute inorganic particles, 1 kg of vapor phase method silica (at an average primary particle diameter of about 12 nm) was prepared. After adding the above additives to the above silica, the resulting mixture was dispersed employing a high-pressure homogenizer, produced by Sanwa Co., Ltd., and the total volume was brought to 5,500 ml by the addition of water, whereby Silica Dispersion D-1 was prepared. 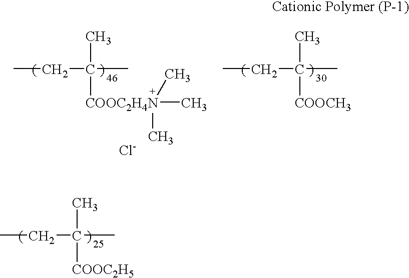
(Preparation of Silica Dispersion D-2)

Silica Dispersion D-2 was prepared in the same manner as above Silica Dispersion D-1, except that Cationic Polymer (P-1) was replaced with Cationic Polymer (P-2). 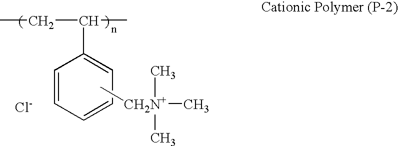
(Preparation of Silica Dispersion D-3)

Silica Dispersion D-3 was prepared in the same manner as above Silica Dispersion D-1, except that Cationic Polymer (P-1) was replaced with an aqueous basic aluminum chloride solution (TAKIBINE #1500 produced by Taki Chemical Co., Ltd., at 23.75% as Al₂O₃) and the added amount of 10% aqueous antifading agent solution was changed to 441.8 ml.

<<Preparation of Ink-Jet Recording Sheets>>

(Preparation of Sample 101)

The 1st-4th layer liquid coating compositions, described below, were applied onto a photographic support (at a thickness of 220 μm) prepared by covering both sides of a base paper at a basis weight of 200 g/m² by polyethylene so that the wet layer thickness reached 55, 55, 55, and 15 μm, respectively. After chilling the coating at 5° C. for 10 seconds, it was dried employing 40° C. air flow, whereby Sample 101 was prepared.

(1st Layer (Lowermost Layer) Liquid Coating Composition)

| | |
|---|---|
| Silica Dispersion D-1 | 550 g |
| Aqueous polyvinyl alcohol (PVA235, produced by | 280 g |
| Kuraray Co., Ltd.) solution at a | |
| concentration of 6% | |

The total liquid composition was brought to 1,000 ml by the addition of pure water, whereby a liquid coating composition was prepared.

(2nd Layer Liquid Coating Composition)

| | |
|---|---|
| Silica Dispersion D-1 | 550 g |
| Aqueous polyvinyl alcohol (PVA235, produced by | 280 g |
| Kuraray Co., Ltd.) solution at a | |
| concentration of 6% | |

The total liquid composition was brought to 1,000 ml by the addition of pure water, whereby a liquid coating composition was prepared.

(3rd Layer Liquid Coating Composition)

| | |
|---|---|
| Silica Dispersion D-1 | 550 g |
| Aqueous polyvinyl alcohol (PVA235, produced by | 280 g |
| Kuraray Co., Ltd.) solution at a | |
| concentration of 6% | |

The total liquid composition was brought to 1,000 ml by the addition of pure water, whereby a liquid coating composition was prepared.

(4th Layer (Uppermost Layer) Liquid Coating Composition)

| | | |
|---|---|---|
| Silica Dispersion D-3 | 550 | g |
| Aqueous polyvinyl alcohol (PVA235, produced by | 280 | g |
| Kuraray Co., Ltd.) solution at a | | |
| concentration of 6% | | |
| Cationic surface active agent (COATAMINE 24P, | 4 | ml |
| produced by Kao Corp.) | | |

The total liquid composition was brought to 1,000 ml by the addition of pure water, whereby a liquid coating composition was prepared.

(Preparation of Samples 102-124)

Samples 102-124 were prepared in the same manner as Sample 101, except that as described in Table 1 below, the type of antifading agents incorporated into silica dispersions employed in the 1st layer liquid coating composition—the 4th layer liquid coating composition was changed and a 20% aqueous zirconyl acetate solution (employed by diluting ZIRCOSOL ZA, produced by Daiichi Kigenso Kagaku-Kogyo Co., Ltd. by the addition of water), as well as a 10% aqueous antifading agent solution was added. When the 10% aqueous antifading agent solution was added to the liquid coating composition, the added amount was controlled to be the same as that added to the silica dispersion.

Further, Sample 125 was prepared in the same manner as preparing Sample 101 except that ST-1 was replaced with ST-15 (MW=243.31).

Anti-fading agent comparative example ST-A: ADEKA STAB LX335 (emulsion with 50% effective component), produced by Asahi Denka Kogyo K.K. was diluted by the addition of water to reach 10% effective component, and then employed.

The main component of ST-A has a structure LA-62 shown below.

TABLE 1

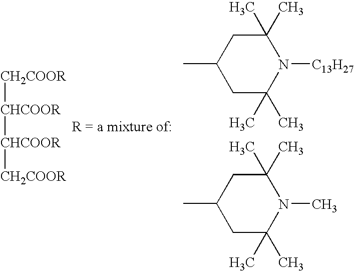

| | | | | | Added Amount of 20% | | | | Antifading Agent Added to | |
|---|---|---|---|---|---|---|---|---|---|---|
| | Type of Antifading Agent Added to | | | | Aqueous Zirconyl Acetate | | | | 1st Layer/2nd | |
| | Silica Dispersion | | | | Solution | | | | Layer Liquid | |
| Sample No. | 1st Layer | 2nd Layer | 3rd Layer | 4th Layer | 1st Lay | 2nd Layer | 3rd Layer | 4th Layer | Coating Composition | Remarks |
| 101 | ST-1 | ST-1 | no | no | — | — | — | — | — | Inv. |
| | | | addition | addition | | | | | | |
| 102 | no | no | ST-1 | ST-1 | — | — | — | — | — | Inv. |
| | addition | addition | | | | | | | | |
| 103 | ST-2 | ST-2 | no | no | — | — | — | — | — | Inv. |
| | | | addition | addition | | | | | | |
| 104 | no | no | ST-2 | ST-2 | — | — | — | — | — | Inv. |
| | addition | addition | | | | | | | | |
| 105 | ST-12 | ST-12 | no | no | — | — | — | — | — | Inv. |
| | | | addition | addition | | | | | | |
| 106 | no | no | ST-12 | ST-12 | — | — | — | — | — | Inv. |
| | addition | addition | | | | | | | | |
| 107 | ST-A | ST-A | no | no | — | — | — | — | — | Comp. |
| | | | addition | addition | | | | | | |
| 108 | no | no | ST-A | ST-A | — | — | — | — | — | Comp. |
| | addition | addition | | | | | | | | |
| 109 | ST-A | ST-A | no | no | — | — | — | 100 ml | — | Comp. |
| | | | addition | addition | | | | | | |
| 110 | no | no | ST-2 | ST-2 | — | — | — | 100 ml | — | Inv. |
| | addition | addition | | | | | | | | |
| 111 | ST-2 | ST-2 | no | no | — | — | — | 100 ml | — | Inv. |
| | | | addition | addition | | | | | | |
| 112 | ST-2 | ST-2 | no | no | — | — | 27.3 ml | — | — | Inv. |
| | | | addition | addition | | | | | | |
| 113 | ST-2 | ST-2 | no | no | — | — | 13.6 ml | 50 ml | — | Inv. |
| | | | addition | addition | | | | | | |
| 114 | ST-2 | ST-2 | no | no | — | 27.3 ml | — | — | — | Inv. |
| | | | addition | addition | | | | | | |
| 115 | ST-2 | ST-2 | no | no | — | 13.6 ml | — | 50 ml | — | Inv. |
| | | | addition | addition | | | | | | |
| 116 | ST-1 | ST-1 | no | no | — | — | — | 100 ml | — | Inv. |
| | | | addition | addition | | | | | | |
| 117 | ST-1 | ST-1 | no | no | — | — | 27.3 ml | — | — | Inv. |
| | | | addition | addition | | | | | | |
| 118 | ST-1 | ST-1 | no | no | — | — | 13.6 ml | 50 ml | — | Inv. |
| | | | addition | addition | | | | | | |
| 119 | ST-1 | ST-1 | no | no | — | 27.3 ml | — | — | — | Inv. |
| | | | addition | addition | | | | | | |
| 120 | ST-1 | ST-1 | no | no | — | 13.6 ml | — | 50 ml | — | Inv. |
| | | | addition | addition | | | | | | |
| 121 | no | no | no | no | — | — | — | — | ST-1 | Inv. |
| | addition | addition | addition | addition | | | | | | |
| 122 | no | no | no | no | — | — | — | — | ST-2 | Inv. |
| | addition | addition | addition | addition | | | | | | |
| 123 | no | no | no | no | — | — | — | — | ST-A | Comp. |
| | addition | addition | addition | addition | | | | | | |
| 124 | no | no | no | no | — | — | — | — | — | Comp. |
| | addition | addition | addition | addition | | | | | | |
| 125 | ST-15 | ST-15 | no | no | — | — | 13.6 ml | 50 ml | — | Inv. |
| | | | addition | addition | | | | | | |

Inv.: Present Invention,
Comp.: Comparative Example

<<Evaluation>>

Each of the ink-jet recording sheets prepared employing the above methods was evaluated as follows.

(Light Fastness)

Solid yellow and magenta images were printed onto each of the Samples, employing an ink-jet printer, PIXUS 860i, produced by Canon Inc. Subsequently, the printed samples were exposed to 70,000 lux light for 100 hours, employing a xenon arc lamp. Light fastness was represented by the residual ratio to the initial density.

By employing ink-jet printer PIXUS 860i, produced by Canon Inc., fine lines at a width of approximately 0.3 mm were printed onto each recording sheet onto which a solid magenta background had been printed, employing the genuine ink. After allowing the printed sample to stand for 5 minutes, it was stored at 50° C. and 85% relative humidity for 5 days. Bleeding of fine lines prior to and after the above storage was evaluated based on the 4 rankings below.
A: no bleeding was noted, exhibiting an excellent definition
B: slight bleeding was noted, exhibiting a good definition
C: some bleeding was noted, exhibiting degradation of definition
D: bleeding was clearly noted, exhibiting remarkable degradation of definition
   (Color Forming Properties)

A solid black image was printed on each of the samples, employing ink-jet printer PIXUS 860i, produced by Canon Inc. Maximum density (Dmax) was determined employing a reflection densitometer, and color forming properties were evaluated.

(Non-Uniformity)

A solid green image was outputted on each of the samples and image uniformity was evaluated.
A: the solid image was completely uniform
B: uniformity was noted when viewed at least 30 cm from the image
C: uniformity was noted when viewed at least 60 cm from the image
D: non-uniformity was noted when viewed 60 cm from the image

Table 2 shows the results.

TABLE 2

| | | | Color | | | |
|---|---|---|---|---|---|---|
| Sample | Light fastness | | Forming | Bleeding on | | |
| No. | Yellow | Magenta | Properties | Standing | Non-Uniformity | Remarks |
| 101 | 73 | 82 | 2.33 | B | B | Inv. |
| 102 | 75 | 82 | 2.30 | C | B | Inv. |
| 103 | 77 | 84 | 2.41 | A | B | Inv. |
| 104 | 76 | 83 | 2.38 | B | B | Inv. |
| 105 | 67 | 76 | 2.30 | A | B | Inv. |
| 106 | 66 | 77 | 2.27 | B | B | Inv. |
| 107 | 62 | 73 | 2.08 | A | D | Comp. |
| 108 | 61 | 73 | 1.97 | A | D | Comp. |
| 109 | 62 | 72 | 2.12 | A | D | Comp. |
| 110 | 75 | 83 | 2.39 | B | A | Inv. |
| 111 | 75 | 84 | 2.41 | A | A | Inv. |
| 112 | 75 | 84 | 2.40 | A | A | Inv. |
| 113 | 76 | 83 | 2.40 | A | A | Inv. |
| 114 | 75 | 83 | 2.31 | A | B | Inv. |
| 115 | 75 | 82 | 2.35 | A | B | Inv. |
| 116 | 74 | 82 | 2.31 | A | A | Inv. |
| 117 | 75 | 81 | 2.33 | A | A | Inv. |
| 118 | 74 | 82 | 2.32 | A | A | Inv. |
| 119 | 73 | 82 | 2.28 | A | B | Inv. |
| 120 | 74 | 81 | 2.28 | A | B | Inv. |
| 121 | 72 | 80 | 2.30 | B | B | Inv. |
| 122 | 74 | 82 | 2.33 | A | B | Inv. |
| 123 | 62 | 72 | 2.14 | A | D | Comp. |
| 124 | 58 | 69 | 2.32 | B | B | Comp. |
| 125 | 71 | 70 | 2.08 | B | B | Inv. |

Inv.: Present Invention,
Comp.: Comparative Example

Based on Table 2, it is seen that the ink-jet recording sheets of the present invention result in excellent light fastness and color forming properties, as well as minimize bleeding during standing and non-uniformity.

### Example 2

Example in the Case of Employing Photo-linking Type PVA

<<Preparation of Silica Dispersion>>

(Preparation of Silica Dispersion S-1)

While stirring at 3,000 rpm and room temperature, added to 330 g of Aqueous Solution C-1 (at a pH of 2.5, containing 60 g of antifoamer SN-391 produced by San Nobuko Co.) containing 10% n-propanol, and 2% ethanol were 1,200 g of previously uniformly dispersed Silica Dispersion B1 (at a pH of 2.6, containing 0.5% ethanol) containing 30% vapor phase method silica (AEROSIL 300, produced by Nippon Aerosil Co., Ltd.) at a primary particle diameter of approximately 0.007 μm and 12% Cationic Polymer Dispersing Agent P-1.

Subsequently, the resulting mixture was dispersed at a pressure of 3,000 N/cm², employing a high-pressure homogenizer, produced by Sanwa Industry Co., Ltd., and the total volume was finished by the addition of pure water, whereby almost transparent Silica Dispersion S-1 was obtained.

<<Preparation of Sample 201>>

While stirring, gradually added to 3,000 g of above Silica Dispersion (S-1) were 960 g of an aqueous solution of ultraviolet radiation crosslinking type polyvinyl alcohol derivative (Compound-1 at a degree of polymerization of the main chain PVA of 3,000, a saponification ratio of 88%, and a crosslinking group modification ratio of 1 mol %) represented by Formula (1), prepared referring to the example of JP-A No. 2000-181062 and 1.5 g of a photoinitiator (KAYACURE GTX,. produced by Nippon Kayaku Co., Ltd.), and the resulting mixture was brought to 6,000 g by the addition of pure water, whereby Liquid Coating Composition T-1 was prepared.

The resulting Liquid Coating Composition T-1 was filtered employing a TCP-10 type filter, produced by Advantechs Toyo Co.

Subsequently, above Liquid Coating Composition T-1 was subjected to two-layer simultaneous coating onto the recording side of a photographic support (at a thickness of 220 μm) to result in a silica coated amount of 13 g/m² per layer. Thereafter, by employing a metal halide lamp which emits ultraviolet radiation having a dominant wavelength of 364 nm, the above coating was exposed to ultraviolet radiation exhibiting an illuminance of 60 mW/cm² to reach an energy amount of 30 mJ/cm², and subsequently was dried employing hot air flow at 80° C., whereby Sample 201 was prepared.

<<Preparation of Samples 202-209>>

Samples 202-209 were prepared in the same manner as Sample 1, except that during the preparation of Silica Dispersion S-1 Liquid Coating Composition T-1, a 10% anti-fading agent solution and a 20% aqueous zirconyl acetate solution (prepared by diluting ZIRCOSOL ZA, produced by Daiichi Kigenso Kogyo Co., Litd. with water) were added as described in Table 3. Further, the coated amount of the anti-fading agent and zirconyl acetate was controlled to 0.1 g/m² and 0.3 g/m², respectively.

TABLE 3

| | | | Addition of 20% | | | |
|---|---|---|---|---|---|---|
| | Type of Anti- | | Aqueous | | Anti-Fading | |
| | Fading Agent | | Zirconyl | | Agent Added | |
| | Added to Silica | | Acetate | | to Lower | |
| | Dispersion | | Solution | | Layer Liquid | |
| Sample | Lower | Upper | Lower | Upper | Coating | |
| No. | Layer | Layer | Layer | Layer | Composition | Remarks |
| 201 | *1 | *1 | — | — | — | Comp. |
| 202 | ST-1 | *1 | — | — | — | Inv. |
| 203 | *1 | ST-1 | — | — | — | Inv. |
| 204 | ST-2 | *1 | — | — | — | Inv. |
| 205 | *1 | ST-2 | — | — | — | Inv. |
| 206 | ST-12 | *1 | — | — | — | Inv. |
| 207 | *1 | ST-12 | — | — | — | Inv. |
| 208 | ST-A | *1 | — | — | — | Comp. |
| 209 | *1 | ST-A | — | — | — | Comp. |
| 210 | ST-A | *1 | — | present | — | Comp. |
| 211 | *1 | ST-2 | — | present | — | Inv. |
| 212 | ST-2 | *1 | — | present | — | Inv. |
| 213 | ST-2 | *1 | present | — | — | Inv. |
| 214 | ST-2 | *1 | present | present | — | Inv. |
| 215 | ST-1 | *1 | — | present | — | Inv. |
| 216 | ST-1 | *1 | present | — | — | Inv. |
| 217 | ST-1 | *1 | present | present | — | Inv. |
| 218 | *1 | *1 | — | — | ST-1 | Inv. |
| 219 | *1 | *1 | — | — | ST-2 | Inv. |
| 220 | *1 | *1 | — | — | ST-A | Comp. |

*) Lower Layer: a layer near the support, Upper Layer: a layer arther from the support
*) Zirconyl acetate employed in each of Samples 214 and 217 was divided into two portions in an equal amount, each of which was added to the upper layer and the lower layer.
*1: no addition

<<Evaluation>>

Each ink-jet sheet prepared employing the above method was evaluated in the same manner as Example 1. Table 4 shows the results.

TABLE 4

| | | | Color | | | |
|---|---|---|---|---|---|---|
| Sample | Light fastness | | Forming | Bleeding on | | |
| No. | Yellow | Magenta | Properties | Standing | Non-uniformity | Remarks |
| 201 | 51 | 60 | 2.22 | B | B | Comp. |
| 202 | 69 | 77 | 2.23 | B | B | Inv. |
| 203 | 68 | 79 | 2.21 | C | B | Inv. |
| 204 | 72 | 81 | 2.32 | A | B | Inv. |
| 205 | 72 | 80 | 2.30 | B | B | Inv. |
| 206 | 60 | 71 | 2.21 | A | B | Inv. |
| 207 | 61 | 69 | 2.20 | B | B | Inv. |
| 208 | 57 | 64 | 1.99 | A | D | Comp. |
| 209 | 56 | 64 | 1.91 | A | D | Comp. |
| 210 | 57 | 65 | 2.03 | A | D | Comp. |
| 211 | 71 | 81 | 2.32 | B | A | Inv. |
| 212 | 72 | 82 | 2.33 | A | A | Inv. |
| 213 | 70 | 80 | 2.30 | A | B | Inv. |
| 214 | 70 | 81 | 2.30 | A | B | Inv. |
| 215 | 68 | 78 | 2.25 | A | A | Inv. |
| 216 | 69 | 78 | 2.22 | A | B | Inv. |
| 217 | 69 | 77 | 2.22 | A | B | Inv. |
| 218 | 68 | 77 | 2.21 | B | B | Inv. |
| 219 | 72 | 80 | 2.29 | A | B | Inv. |
| 220 | 56 | 66 | 2.01 | A | D | Comp. |

Inv.: Present Invention,
Comp.: Comparative Example

It is can seen form Table 4 that even when the,employed binder is changed to ultraviolet radiation crosslinking type polyvinyl alcohol, the ink-jet recording sheets of the present invention resulted in excellent light fastness and color forming properties, as well as minimize bleeding on standing and non-uniformity.

What is claimed is:

1. An ink-jet recording sheet comprising a support having thereon an ink absorptive layer comprising inorganic microparticles, a binder and a compound represented by Formula (1): 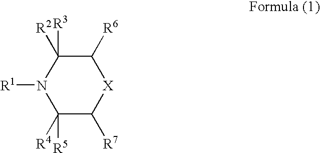
wherein R¹ represents a hydrogen atom, a hydroxyl group, an alkyl group, an alkenyl group, or an acyl group; R², R³; R⁴₁ and R⁵ each independently represents a hydrogen atom, a methyl group , or an ethyl group; R⁶ and R⁷ each independently represents a hydrogen atom or a methyl group; X represents a chalcogen atom, N(R⁹), or C(R⁹) (R¹⁰) in which R⁸, R⁹₁ and R¹⁰ each independently represents a hydrogen atom or a substituent.

2. The ink-jet recording sheet of claim 1, wherein R¹ in Formula (1) represents a hydroxyl group.

3. The ink-jet recording sheet of claim 1, wherein the compound represented by Formula (1) has a molecular weight of not more than 300.

4. The ink-jet recording sheet of claim 1, comprising at least two ink absorptive layers,
wherein the compound represented by Formula (1) is contained within a distance of 60% of the total thickness of the ink absorptive layers, the distance being measured from a surface of the support on which the ink-absorptive layers are provided.

5. The ink-jet recording sheet of claim 4,
wherein at least one of the ink absorptive layers comprises a polyvalent metal compound, and 80 mole % of the total mol of the polyvalent metal compound is contained within a distance of 60% of the total thickness of the ink absorptive layers, provided that the distance is measured from a surface of the uppermost ink absorptive layer.

6. A method of producing the ink-jet recording sheet of claim 1 comprising the steps of:
preparing a dispersion of the inorganic microparticles;.
adding the compound represented by Formula (1) to the dispersion of inorganic microparticles;
mixing the binder to the dispersion of inorganic microparticles added with the compound represented by Formula (1) so as to obtain a coating position;
applying the coating composition onto the support.
